(19) United States
(12) Patent Application Publication
(10) Pub. No.: US 2015/0356179 A1
(43) Pub. Date: Dec. 10, 2015

(54) SYSTEM, METHOD AND DEVICE FOR SCORING BROWSING SESSIONS

(71) Applicant: YANDEX EUROPE AG, Luzern (CH)

(72) Inventors: Maksim Evgenievich ZHUKOVSKII, Tambov (RU); Gleb Gennadievich GUSEV, Moscow (RU)

(21) Appl. No.: 14/828,720

(22) Filed: Aug. 18, 2015

Related U.S. Application Data
(63) Continuation of application No. PCT/IB2014/058860, filed on Feb. 7, 2014.

(30) Foreign Application Priority Data
Jul. 15, 2013 (RU) PCT/RU2013/000603
Aug. 12, 2013 (RU) 2013137405

(51) Int. Cl. G06F 17/30

(52) U.S. Cl. CPC G06F 17/30864

(57) ABSTRACT

A system, method and device for calculating a page rank of a web page is provided. The method comprises: accessing browsing history data associated with the web page, the browsing history data comprising time data; computing a rank score for the web page utilizing the browsing history data and the time data; and ranking the web page in a list according to the rank score. The method may be executed on a processor. The server comprises: a processor; a database for storing records relating to browsing histories; and page rank software operating on the server providing instructions to the processor executing the method.

### CROSS-REFERENCE TO RELATED APPLICATIONS

This application claims the benefit of the priority of the Russian patent application no. 2013137405 filed on Aug. 12, 2013 and International Patent Application no. PCT/RU2013/000603 filed on Jul. 15, 2013 entitled “System, Method and Device for Scoring Browsing Sessions” which are incorporated herein by reference in their entirety. The present application is a continuation of International Patent Application no. PCT/IB2014/058860, filed on Feb. 7, 2014, entitled “System, Method and Device for Scoring Browsing Sessions”, the entirety of which is incorporated herein by reference.

### FIELD OF THE DISCLOSURE

The field for the present disclosure relates to ranking systems, methods and algorithms for web pages, in particular ranking of web pages in browsing histories.

### BACKGROUND OF THE DISCLOSURE

For Internet searching algorithms, ranking algorithms apply authority scores to web page, which allows web pages to be canonically ranked. With the ranking, search engines can present a list of web pages in a ranked order based on the derived authority scores. One approach to evaluating page importance analyzes a user's browsing histories and determines a web page's importance based on a probability using a stationary distribution analysis of a user's browsing graph.

### SUMMARY OF THE DISCLOSURE

Embodiments of the present technology have been developed based on inventors' appreciation of certain shortcomings associated with the state of the art.

Existing algorithms do not include recency (i.e. time) of a browsing history in their analysis. Therefore, pages that were assigned a high score a few days ago may not be as authoritative for a current search, although the pages would still be attributed with their previous high scores.

Accordingly, there is a need for a system, method, device and technique that attempt to address at least some of the aforementioned issues with the current prior art schemes.

In a first aspect, a method of calculating a page rank of a web page is provided. The method comprises: accessing browsing history data associated with the web page, the browsing history data comprising time data; computing a rank score for the web page utilizing the browsing history data and the time data; and ranking the web page in a list according to the rank score.

In the method, computing the rank score may comprise: calculating a first score utilizing a browse rank score of the browsing history data and the time data; calculating a second score utilizing query dependent component for the web page; and adding the first score adjusted by a first factor with the second score adjusted by a second factor to produce the rank score.

In the method, the first factor may be mathematically related to the second factor.

In the method, the time data may emphasize browsing data from histories that are more recent than browsing data from older histories.

In the method, the time data may comprise first and second instances of time and an interval of time from a first moment in time to a second moment in time.

In the method, computing the rank score may comprise applying a derivative function to a stationary distribution of a Markov process associated with the browser history data.

In the method, computing the rank score for the web page may comprise: selecting a sequence of at least one moment in time within the interval of time; computing a first freshness value for each of the at least one moment in time and a second freshness value for a web page associated with each of the at least one moment in time; and computing a freshness measure for the web page as a function of the first and second freshness values.

In the method, the browsing history data may correspond to an interval of time from a first moment in time to a second moment in time; and computing the rank score for the web page may comprise: selecting a sequence of one or more moments in time within the interval of time, and the second moment in time, where the interval of time is divided into at least one sub-interval of time; computing for the web page a first freshness value for each moment in time of the sequence; computing for the web page a second freshness value for each moment in time of the sequence; and computing a freshness measure for the web page as a function of the first and second freshness values.

In the method, the first moment in time and each moment in time may divide the interval of time into two or more sub-intervals of time.

In the method, computing for the web page the first freshness value may utilize a creation time of the web page and a count of visits to the web page in the browsing history data during a sub-interval of time immediately preceding a sub-interval of time of each moment in time of the sequence.

In the method, computing for the web page the second freshness value may utilize a creation time of the web page and computed freshness values associated with each moment in time for web pages neighbouring the web page.

The method may further comprise computing for the web page an interim freshness measure for each moment in time of the sequence utilizing any corresponding computed interim freshness measure associated with a moment in time in the sequence immediately preceding each moment in time, if any and the second freshness value associated with each moment in time. In the method, the computed freshness measure for the web page may comprise a computed interim freshness measure associated with the second moment in time.

In the method, computing the rank score for the web page may utilize a transition probability corresponding to the web page multiplied by a function of the freshness measure.

In the method, computing the rank score for the web page may comprise: multiplying an estimated staying time for the web page derived from a transition matrix for the browsing history data by a function of the freshness measure; and multiplying a stationary probability distribution for the web page by the function of the freshness measure.

The method may further comprise applying partial derivatives to a first function of the rank score for the web page with a training data of browsing histories to identify values for parameters for a second function generating the rank score.

The method may further comprise: computing a query-dependent ranking for the web page based on a query; and computing a merged ranking for the web page as a function of the query-dependent ranking and the rank score.

In a second aspect, a server for calculating a page rank of a web page is provided. The server comprises: a processor; a database for storing records relating to browsing histories; and page ranking software operating on the server providing instructions to the processor executing any of methods provided above.

In other aspects, various combinations of sets and subsets of the above aspects are provided.

Additional aspects and advantages of the present disclosure will be apparent in view of the description which follows. It should be understood, however, that the detailed description, while indicating embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

With reference to embodiments thereof, the technology will next be described in relation to the drawings, which are intended to be non-limiting examples of various embodiments of the present disclosure, in which:

FIG. 1 is a schematic diagram of a network containing a search engine server and a plurality of servers hosting web sites and a device in communication with the network that is accessing the search engine server according to an embodiment;

FIG. 2 is a schematic representation of a mapping of web site browsing histories of the device of FIG. 1 and other devices and transformations of the browsing histories to a graph and a table for analysis according to an embodiment;

FIG. 3 is a schematic representation of the device of FIG. 1 and its browsing application according to an embodiment;

FIG. 4 is a schematic representation of the search engine server of FIG. 1 and its (web) page rank application according to an embodiment; and

FIG. 5 is a flowchart of an exemplary browse ranking algorithm executed by the page rank application of the search engine server of FIG. 1 according to an embodiment.

### DETAILED DESCRIPTION OF THE DISCLOSURE

Details of example embodiments are provided herein. The description which follows and the embodiments described therein are provided by way of illustration of an example or examples of particular embodiments of principles of the present disclosure. These examples are provided for the purposes of explanation and not limitation of those principles and of the disclosure. In the description which follows, like parts are marked throughout the specification and the drawings with the same respective reference numerals.

Before discussing details on specific features of an embodiment, a description is provided on a network having a device, as a server, that provides connections to other devices, as clients, according to an embodiment. Then, details are provided on an example device in which an embodiment operates.

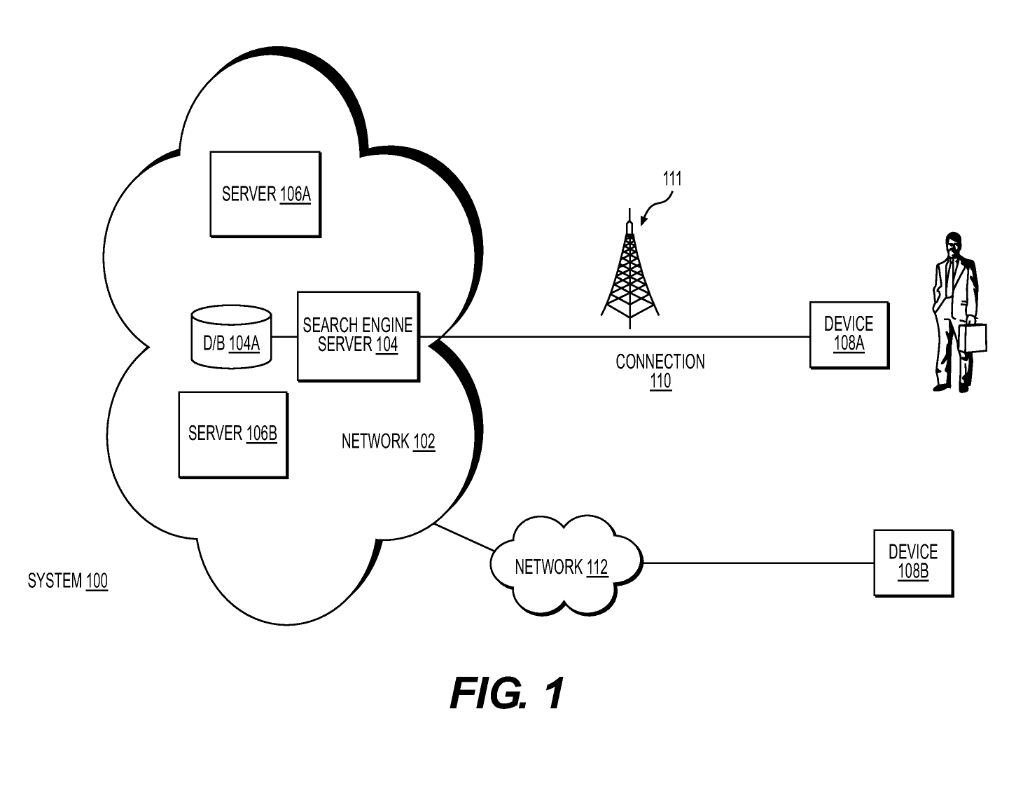

First, details are provided on example networks where devices according to an embodiment may operate. Referring to FIG. 1, details on a system of example networks and communication devices according to an embodiment are provided. FIG. 1 shows a communication system 100 where a network 102 connects search engine server 104 to other servers 106 (i.e. servers 106a and 106b) and device 108a via various communication links. A network 112 may be connected to network 102 via a communication link (not shown) that may be wired or wireless and permanent or temporary. Device 108a is connected to network 102 via communication link 110, which may be wired or wireless and permanent or temporary. In the specific embodiment, the communication link 110 is implemented as a wireless network having a base station 111. Network 102 may be the Internet. Devices connected to network 112, such as device 108b, may access search engine server 104 and other servers 106 through network 112. Two exemplary services are provided to devices 108a, 108b connected (directly or indirectly) to the network 102: website search engines; and general website browsing. Exemplary features of each service are briefly discussed in turn.

For the browsing service through servers 106 in the network 102, device 108b may browse through various websites in the Internet using a web browser in its graphical user interface (GUI). A typical browsing session may have a distinct opening event (e.g. opening of a new browsing window or tab in the GUI) and may have a distinct closing event (e.g. closing of the window for the session by an action of the user or by the browser itself). A session may be deemed to be ended after a certain period of time that the browser session is at a given website (e.g. 15 minutes at the current website displayed in the browser (e.g. www.yahoo.com) without any input activity to change the current website by the device 108b). When a web page is generated in the browser, as a user at device 108b activates a hyperlink in the web page such as through an input device (such as a mouse) that is associated with device 108b over a hyperlink in the web page, a call is initiated to retrieve a web page associated with the hyperlink from the server associated with the address of the hyperlink. The retrieved page, if available, is produced in the GUI and the browsing session continues. A monitoring application may be installed on device 108b relating to the browser that, upon user permission and/or authorization, tracks and monitors browsing sessions and produces data in a browsing history log relating to the sessions. Anonymized information describing a user's browsing activities (including for example, visited pages, times of visiting, submitted queries etc.) is stored in the browsing history log (not depicted).

For the search engine service in network 102, as a typical search engine service, search engine server 104 hosts a search engine web site that presents a GUI on a display of the device 108a, 108b accessing the search engine web site allowing text to be entered to the GUI relating to an Internet query to be executed through search engine server 104. For example, once a query is entered through the GUI (e.g. “What is the capital city of France <CR>”), the text of the query is parsed by search engine server 104; a search is initiated of web pages that are tracked by search engine server 104 to identify a set of web pages that align with the search; and a list of ranked web pages are displayed in the GUI. As a user at the device activates one or more of the search results, a web page from server 106 associated with the activated link is retrieved and displayed on device 108a, 108b.

Data relating to histories of browsing sessions and web engine searches initiated at devices 108a/108b may be tracked and stored at device 108a/108b in their local storage device(s), at search engine server 104 in its local database 104b and/or at other locations (not shown) in network 102. Browsing histories contain records of data relating to each web page visited during a browsing session, including data on when the session was started, how the session was started, what websites were visited, when the websites were visited, what the duration of browsing at each website was, how each web site was accessed, how the session ended and when the session ended and other information about the browsing session. Different portions of the session data may be stored at different locations. Devices 108a, 108b may execute software applications to monitor and track browsing sessions in a browsing history logs (not depicted). Data for browsing histories for one or more devices 108a, 108b may be stored at various locations, e.g. in databases of Internet Search Providers (ISPs), in local browser data files on devices, since browsers and search engines are integrated together in applications (e.g. in Chrome and Yandex), in databases of mobile networks, in data stored by browser plug-ins operating on devices 108a, 108a, 108b and in other applications installed in smartphones and computers. Different devices potentially present in the system 100 may access search engine server 104 and may also locally and/or remotely store data relating to their search histories. Data may be collected and amalgamated from one or more of the different locations and from one or more of the devices 108, then processed and analyzed to identify trends in web-browsing activities from users at devices 108a, 108b accessing search engine server 104. Data for browsing histories may be requested and retrieved from various local and remote sources using data acquisition techniques known in the art.

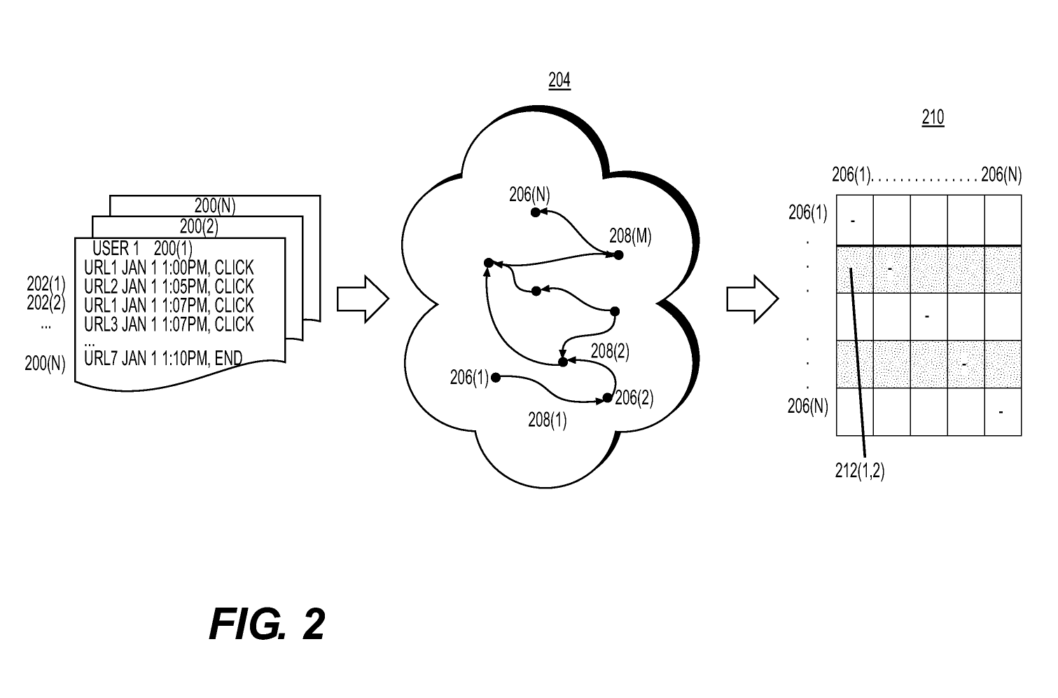

FIG. 2 provides a schematic mapping of browse/search history data from one or more devices 108a, 108b accessing of a mapping tool (not depicted) employed by an embodiment to create and populate data structures to store website browsing histories and patterns. Histories 200(1), 200(2) . . . 200(n) show lists of website visitation data for browsing sessions and/or searching sessions. For example, history 200(1) shows entries 202(1) for device 108a for a browsing session for a particular browsing window conducted around January 1 at around 1:00-1:10 PM. The session information may include one or more of the URLs visited, the time of visitation and the duration of stay on the page and the method of visiting (e.g. URL input or hyperlink click from previous page).

Collectively, histories 200(1) . . . (n) may be mapped into graph 204 representing a browser history for multiple devices 108a, 108b accessing multiple web pages from multiple servers 108a, 108b at different points of time. In graph 204 vertices 206(1), (2) . . . (n) represent web pages (corresponding to URLs) and edges 208(1), (2) . . . (m), shown as directed arrows, show transitions from one web site to another of one device 108a, 108b in its browsing history, where the base of the edge is the current website and the head of the edge (at the arrow) is the resulting destination web site being visited after a transition (e.g. after activation of a hyperlink in a current website to move to another website). There may be multiple edge 208 connecting two vertices 206 where different vertices reflect the noted web page transitions initiated independently by different devices 108a, 108b. Alternatively, edge 208 connecting two vertices 206 may reflect a collective web page transitions for all devices 108a, 108b. Graph 204 shows all browsing histories 200(1) . . . (n) and does not reflect, in this view, specific single browsing histories. A feature of an embodiment maps browsing histories and generates a dataset, akin to graph 204, with additional temporal information (as to the date/time of each browsing session used to populate the graph) and then applies data shaping algorithms to rank pages utilizing a browsing graph, such as graph 204. The data may be provided from Internet browsers at devices 108a, 108b and/or collected from the servers 106.

Graph 204 may be presented in table format, as foe example a table 210, containing rows and columns for each of the vertices 206(1), (2) . . . (n) represent web pages and cells 212 at the (i, j th) entry in table 210 represent browsing data for a transition from vertex 206i to vertex 206j in graph 204. Entries in the diagonal at (i, i th) entry in table 210 represent browsing data of remaining at vertex i in the browsing session. For example, the entries may include time data (e.g. reflecting the time when there was a transition between web pages for one or more instances (derived from browsing histories from one or more sources), transition data (e.g. reflecting how transitions were activated), location data (e.g. reflecting the locations of the computers where the web pages were being browsed) and other data (e.g. reflecting the type of browsing software used, etc.). It will be appreciated that table 210 contains data that can be provided from browsing histories data or from other sources.

One aspect of an embodiment provides a temporal factor (namely a “freshness” factor) that is used to apply a weighting value to a web page that is present in a browsing history for a web session. This freshness factor is calculated based on entries in table 210 and is used as a factor in ranking an importance of a web page in a browsing history.

In describing features of an embodiment, for the purpose of illustration and not limitation, the following terms and related definitions are provided describing characteristics and relationships in data relating to browsing sessions. The terms are provided in exemplary equations that one embodiment employs to map and rank aspects of the browsing sessions.

For a browsing session (denoted herein as “S”) conducted on device 108, the web pages visited in session S are denoted as pages p₁(S), p₂(S), . . . pₖ₍ₛ₎(S). In the browsing history for each i ε{1, 2, . . . , k(S)−1} a record p₁(S) transitioning to pᵢ₊₁(S) is made (“pᵢ(S)→pᵢ₊₁(S)”). Pages pᵢ(S), pᵢ₊₁(S) are neighboring elements of the session S.

For each page (“p”) in the browsing history, s(p) represents the number of sessions that have been initiated at page “p”. For each pair of neighboring elements {pᵢ, pᵢ₊₁} from a session, I(pᵢ, pᵢ₊₁) represents the number of sessions containing that pair of neighboring elements.

Graph 204 is algebraically represented as G=(V, E), which can be seen as another algebraic representation of data presented in table 210. Therein, a set of vertices V (representing vertices 206) include all web pages identified in the browsing histories and includes additional vertex x. The set of directed edges E (representing edges 208) include ordered pairs of neighboring elements {p1, p2}. The set E also includes additional edges from the last pages of all the sessions to vertex x.

Reset probability σ(p) is denoted as a probability of choosing page p when a new browsing session is started. It is proportional to a number of sessions s(p) starting from the page p. As such for one embodiment, the reset probability can be set to zero, so that σ(x)=0.

I(p, x) denotes the number of sessions of the browsing histories that end on page p, where p→x εE. Transition probability “ω” represents a probability of activating a hyper link on page p₁ to transit to p₂ (“p₁→p₂”), so that:

$$ω ( {p}_{1} -> {p}_{2} ) = I ( {p}_{1} , p \text{/} ( {\sum }_{{p}_{1} -> p ∈ E}^{ } I ( {p}_{1} , p ) ) \qquad Equation 1$$

Q (p) represents an estimated staying time in a browsing history at page p. A ranking value of page p, noted as a browse rank BR(p), is represented by:

BR(p)=Q(p)π(p), Equation 2

where

$$π ( p ) = \tilde{α} ( p ) σ ( p ) + ( 1 - α ) {\sum }_{\tilde{p} \neq x \text{:} \tilde{p} -> p ∈ E}^{ } ω ( \tilde{p} -> p ) π ( \tilde{p} ) \qquad Equation 3$$

It will be appreciated that Equations 2 and 3 hold for p=x as well, where

~α(p)=α(1−π(x))+π(x).

A variable that an embodiment introduces into evaluating a browsing session is timeliness. Generally, BR (p) may not reflect the freshness of links in a browsing history. As such, rankings based on BR (p) alone may provide results where a user is present with rankings where “old” and “fresh” links have probabilities that are similar as there is no time component factored into their probabilities. An embodiment incorporates a freshness measure to browsing histories, providing a Freshness Browsing Probability (FBR) function. Further details on this freshness measure is provided below.

For an embodiment, as part of a freshness measure, time intervals for a browsing session are used to measure the “freshness” of a page in the session. For a browsing session having two instances of time τ and T, where τ<T, a time interval [τ, T] is divided into K parts, so that for the set of times [Tᵢ₋₁, tᵢ],

i ε{1,2, . . . ,K},iε{1,2, . . . ,K},

t₀=τ,t₀=τ

tᵢ−tᵢ₋₁=(T−τ)/K tᵢ−tᵢ₋₁=(T−τ)/K Equation 4

Time t(p) represents the time (e.g. the date) when page p from V was created. Vertex x is considered to be created at moment τ. For time interval i ε{1, 2, . . . K}, p εV is defined as a vertex (web page) created before moment tᵢ.

An embodiment calculates a freshness score to a browser page, which can then be used in a ranking algorithm when assessing browsing histories. An embodiment defines the function F (“Freshness”) at time t=i for an initial value F⁰ᵢ (p) representing a freshness value of page p and its links as follows:

F⁰ᵢ(p)=a⁰nᵢ(p)+b⁰mᵢ(p),p≠x, Equation 5a

where a⁰ and b⁰ are non-negative parameters, nᵢ(p)=1 if the vertex p is created in the i-th period, otherwise nᵢ(p)=0; mᵢ(p) is the number of visits of page in the i-th period. As an initial calculation, an embodiment can set F⁰ᵢ(x)=0. In Equation 5, the higher the value of Fⁿᵢ(x), the “fresher” its score.

Expressed differently, an embodiment provides a freshness value for web page p, (“f(p)”) that is based on a combination of a plurality of factors each of which may be provided with a weighting value relative to the other factors. In one embodiment, f(p) for web page p includes a FBR(p) component and a query dependent component (“QD(p)”) for the web page. The QD component may be provided from a document ranking function, such as BM25 (or “Okapi BM25”).

As such, a f(p) may be expressed as:

f_{q}(p)=λFBR(p)+(1−λ)QD(p,q) Equation 5b

where λ may be a value between 0 and 1. As such, the first factor for FBR(p) is mathematically related to the second factor for QD(p, q). Here, the mathematical relationship inversely scales the two components by the λ and (1−λ) factors. In other embodiments, independent factors can be applied to the FBR and QD components.

Equation 5a provides a calculation for an initial measure F⁰ᵢ(p). Equation 6, below, provides an incremental (delta) freshness value that is based on spreading the initial freshness value over vertices towards the outgoing edges of a graph. In one embodiment, spreading involves using the time associated with the browsing history (as a time marker as a freshness value for the web pages in the browser history) and arithmetically distributing a component of the time across the web pages in the browsing history as part of a rank score for the web pages. For example, in the browsing history, a transition from web page X to web page Y on Jan. 1, 2013 will be provided a certain rank score based on the freshness of that transition relative to the date of the execution of a ranking algorithm by an embodiment. Also, from the browsing history, a transition from web page X to web page Y on Feb. 1, 2013 will be provided another rank score based on the freshness of that transition relative to the date of the execution of the ranking algorithm. The transition executed on Feb. 1, 2013 may be ranked higher (i.e. more prominently) than the transition executed on Jan. 1, 2013, as the Feb. 1, 2013 transition is more recent than the Jan. 1, 2013 transition. For an embodiment, an incremental freshness value is calculated as follows:

$$Δ {F}_{i} ( p ) = μ {F}_{i}^{0} ( p ) + ( 1 - μ ) {\sum }_{\tilde{p} \neq x \text{:} \tilde{p} -> p ∈ E}^{ } \frac{{W}_{i} ( p )}{{\sum }_{{p}^{′} ∈ V \text{:} \tilde{p} -> {p}^{′} ∈ E}^{ } {W}_{i} ( {p}^{′} )} Δ {F}_{i} ( \tilde{p} ) \qquad Equation 6$$

where με[0, 1]. Wᵢ(p) is a score assigned by the “local” freshness measure to the vertex p in the i-th period. This local measure is defined in the same way as initial measure F⁰ᵢ values:

$${W}_{i} ( p ) = {a}^{1} {n}_{i} ( p ) + {b}^{1} {m}_{i} ( p ) + {\sum }_{j \leq i}^{ } {n}_{j} ( p ) , {a}^{1} , {b}^{1} \geq 0. \qquad Equation 7$$

An embodiment spreads the freshness measure through outgoing links from a page even if there are no fresh links among them. As such, in calculation, the weight of the page is increased by a value (e.g. increased by a value of 1) if it was created before moment tᵢ. The results of Equation 7 illustrate an influence of neighbors on the freshness measure of the page.

With the above equations defined, an embodiment defines a freshness measure, Fᵢ as follows:

Fᵢ(p)=βFᵢ₋₁(p)+ΔFᵢ(p) Equation 8

As a general feature, the freshness measure decreases as time goes if there are no activities concerned with the vertex p (the parameter β is from (0, 1)). The decrease may be linear, non-linear or exponential. One embodiment applies an exponential decrease, such that:

Fᵢ(p)=βΔF₀(p) Equation 9

if there were no browsing activities during the period [τ, tᵢ]. Equations 8 and 9 provide exemplary formulae which may be implemented in an algorithm for arithmetically distributing a component of the time across the web pages in the browsing history as part of the rank score for the web pages.

An example of application of a freshness analysis in a browse history by an embodiment is now provided, where for Equation 7 all considered vertices and edges have been assumed to be created before the time tᵢ.

For the example, the freshness measure assigns to page p in graph G a freshness score F_{K}(p). The value for the number of sessions, I, is factored with a freshness probability score, such that I(p₁, p₂) is replaced with I(p₁, p₂)×F_{K}(p₂). As such, a fresh transition probability ω_{F}(p1→p2) of edge p1→p2 is provided as:

$${π}_{F} ( p ) = \tilde{α} ( p ) σ ( p ) + ( 1 - α ) {\sum }_{\tilde{p} \neq x \text{:} \tilde{p} -> p ∈ E}^{ } {ω}_{F} ( \tilde{p} -> p ) {π}_{F} ( \tilde{p} ) . \qquad Equation 10$$

where

TABLE A

| Parameter | Description |
|---|---|
| [τ; T] | the considered period of time |
| K | the number of time intervals |
| a₀ | the gain F⁰ᵢ (p) receives if t(p) = i |
| a₁ | the gain Wi(p) receives if t(p) = i |
| b₀ | the gain F⁰ᵢ (p) receives if a user clicks to p in the i-th period |
| b₁ | the gain Wi(p) receives if a user clicks to p in the i-th period |
| μ | damping factor for Fi(p) calculating damping factor for FBR |
| | score calculating |
| β | the rate of decreasing of Fᵢ(p) |

Following is a description of processes used to identify some exemplary values for the parameters provided in Table A. Once values Table A are determined, then a time-based rank for a web page can be computed using Equation 10.

Following is a description of another features of an embodiment. For an exemplary set of browser history data, f_{q}(p) represents a freshness value for a page p for a query q, to which a query dependency component is added (per Equation 5b). Exemplary browsing histories comprise sets of pages V¹_{q}, V²_{q}, . . . V^{k}_{q} for each query q, which are ordered from the most relevant (“most recent”) to least relevant (“oldest”) pages. In other words, V¹_{q}, is the set of all pages with the highest score selected from among k labels, pages from the set V^{k}_{q} have the lowest score. For any two pages p₁εp₂εV_{q}^{j}, a penalty score, h, is a loss function. In an embodiment, h (i, j, f_{q}(p₂)−f_{q}(p₁)) is a penalty value imposed if the position of page p₁ according to a ranking algorithm is higher than the position of page p₂ but i<j. For the loss function, an embodiment considers a loss with margins bᵢⱼ>0, where bᵢⱼ are fixed for each pair i,j and where 1≦i<j≦k, where h (i, j, x)=min {x+bᵢⱼ, 0}², namely where h (i, j, x)=0 if x+bᵢⱼ>0, otherwise, h (i, j, x)=(x+bᵢⱼ)². A vector ω represents a vector of parameters of browser history values. For an embodiment, the freshness value in

$$F ( ω ) = {\sum }_{q}^{ } {\sum }_{1 \leq i \leq j \leq k}^{ } {\sum }_{{p}_{1} ∈ {V}_{q}^{t} , {p}_{2} ∈ {V}_{q}^{1}}^{ } h ( i , j , {f}_{q} ( {p}_{2} ) - {f}_{q} ( {p}_{1} ) ) \qquad Equation 11$$

may be minimized by a gradient-based optimization analysis, such as gradient descent. As part of an optimization analysis, a gradient may be calculated for π_{f} (p) instead of F (ω), since F (ω) is the sum of the functions h (i, j, x) and since the function h is composed of h(x) and fₚ(x). As such:

$$\frac{\partial F}{\partial ω} = {\sum }_{i , j , q , {p}_{1} , {p}_{2}}^{ } \frac{\partial h}{\partial x} ( i , j , x ) {\vert}_{x = {f}_{q} ( {p}_{2} ) - {f}_{q} ( {p}_{1} )} ( \frac{\partial {f}_{q}}{\partial ω} ( {p}_{2} ) - \frac{\partial {f}_{q}}{\partial ω} ( {p}_{1} ) ) \qquad Equation 12$$

and as such:

$$\frac{\partial {f}_{q}}{\partial ω} ( p ) = Q ( p ) \frac{\partial π v}{\partial ω} ( p ) . \qquad Equation 13$$

It will be appreciated that parameters for a fresh ranking algorithm may involve tuning of its parameters. While such tuning may be achieved via various methods (e.g. manually, iteratively, trial and error, etc.), an embodiment provides a formulaic method for identifying appropriate values for the parameters of Equation 10, using derivatives.

In particular, an embodiment applies a derivative function to a stationary distribution of a Markov process of a browser history when its transition probabilities are functions of a stationary distribution of another Markov process. Partial derivatives ∂π_{Fresh}/∂α, ∂π_{F}/∂β as solutions of a system of linear equations may be found by solving the equations:

$$\begin{matrix}\frac{\partial {π}_{F}}{\partial α} ( p ) = σ ( p ) ( 1 - {π}_{F} ( x ) + ( 1 - α ) \frac{\partial {π}_{F}}{\partial α} ( x ) ) + {\sum }_{\tilde{p} \neq x \text{:} \tilde{p} -> p ∈ E}^{ } {ω}_{F} ( \tilde{p} -> p ) ( ( 1 - α ) \frac{\partial {π}_{F}}{\partial α} ( \tilde{p} ) - {π}_{F} ( \tilde{p} ) ) ; & Equation 14 \\ \frac{\partial {π}_{F}}{\partial β} ( p ) = σ ( p ) ( 1 - α ) \frac{\partial {π}_{F}}{\partial β} ( x ) + ( 1 - α ) \times {\sum }_{\tilde{p} \neq x \text{:} \tilde{p} -> p ∈ E}^{ } ( {ω}_{F} ( \tilde{p} -> p ) \frac{\partial {π}_{F}}{\partial β} ( \tilde{p} ) + \frac{\partial {ω}_{F}}{\partial β} ( \tilde{p} -> p ) {π}_{F} ( \tilde{p} ) ) & Equation 15\end{matrix}$$

A solution for the derivative ∂ω/∂β(q→p) may be determined by finding ∂Fₖ/∂β (p) from the following equation:

$$\frac{\partial {F}_{K}}{\partial β} ( p ) = {\sum }_{i = 0}^{k - 1} ( i + 1 ) {β}^{i} Δ {F}_{i + 1} ( p ) \qquad Equation 16$$

As such, an embodiment may utilize a system of linear equations having solutions for ∂π_{F}/∂μ, ∂π_{F}/∂a₀, ∂π_{F}/∂a₁ (derivatives ∂π_{F}/∂b₀, ∂π_{F}/∂b₁ are the solutions of the same equations).
The first equations of the system of linear equations may be the same as Equation 15. By choosing a parameter for β, the remaining values to be determined are for ∂ΔFᵢ/∂μ, ∂ΔFᵢ, /∂a₀ and ∂ΔFᵢ/∂a₁ For an embodiment, these values are determined as follows:

$$\begin{matrix}\frac{\partial Δ {F}_{i}}{\partial μ} ( p ) = {F}_{i}^{0} ( p ) + {\sum }_{\tilde{p} \neq x \text{:} \tilde{p} -> p ∈ E}^{ } {W}_{i} ( \tilde{p} -> p ) ( ( 1 - μ ) \frac{\partial Δ {F}_{i}}{\partial μ} ( \tilde{p} ) - Δ {F}_{i} ( \tilde{p} ) ) \\ where {W}_{i} ( \tilde{p} -> p ) = {W}_{i} ( p ) \text{/} ( {\sum }_{{p}^{′} ∈ V \text{:} \tilde{p} -> {p}^{′} ∈ E}^{ } {W}_{i} ( {p}^{′} ) ) ; & Equation 17 \\ \frac{\partial Δ {F}_{i}}{\partial {a}^{0}} ( p ) = μ {n}_{i} ( p ) + ( 1 - μ ) {\sum }_{\tilde{p} \neq x \text{:} \tilde{p} -> p ∈ E}^{ } {W}_{i} ( \tilde{p} -> p ) \frac{\partial Δ {F}_{i}}{\partial {a}^{0}} ( \tilde{p} ) \\ \frac{\partial Δ {F}_{i}}{\partial {a}^{1}} ( p ) = ( 1 - μ ) {\sum }_{\tilde{p} \neq x \text{:} \tilde{p} -> p ∈ E}^{ } ( {W}_{i} ( \tilde{p} -> p ) \frac{\partial Δ {F}_{i}}{\partial {a}^{1}} ( \tilde{p} ) + \frac{\partial {W}_{i}}{\partial {a}^{1}} ( \tilde{p} -> p ) Δ {F}_{i} ( \tilde{p} ) ) . & Equation 18\end{matrix}$$

From Equations 17 and 18, values for different parameters (e.g. α, a⁰ and a¹) can be produced for selected time intervals. As such, for an embodiment, values for parameters τ, T, K are identified and populated into Equations 17-18 to produce the values for the parameters. Values for parameters τ, T, K may be chosen from a relatively small number of values. For example, an embodiment may utilize a period of time [τ, T] for a period of 1 week and parameter K may be selected so that the length of one period [tᵢ₋₁, tᵢ] is selected from different time values, such as web pages being 1 day old, 6 hours old, 3 hours old and 1 hour old. More recent, newer (namely “fresher”) pages contained in browsing histories may be ranked higher than older pages. As such, the time data incorporated in the browsing history data emphasizes results in the history that are more recent than browsing data that are older in the history. Other time periods and intervals may be used. It will be appreciated that an embodiment may use different parameters for identifying fresher pages from older pages. One embodiment may use a relative threshold (e.g. fresher pages are pages browsed within the last hour, day, week, month etc. of the current date or an event) or an parameters for identifying fresher pages from older pages. One embodiment may use an absolute threshold (e.g. fresher pages are pages browsed before Jan. 1, 2013 or another set date or time or event).

Once values for parameters are produced from Equations 17 and 18, effectively, values for the parameters listed in Table A have been identified. As such, a time-based rank for a web page can be computed using Equation 10 using all the calculated values, producing a score for a web page. The process can be repeated for N web pages producing N scores and the web pages can be ranked according to the scores. As such, when device 108a, 108b is accessing search engine server 104 and when device 108a, 108b submits a search query to server 104, server 104 can analyze data relating to browsing histories that it has access to, select appropriate values for time frames, calculate parameters for the FBR equations (e.g. equations 17 and 18), calculate time based browsing history scores for web pages, rank the scored web pages and send the results of the search to device 108a, 108b for generation on its display, showing a ranked list of web pages as the search results for the search query.

Further detail is provided on devices that collectively implement all features of an embodiment described herein.

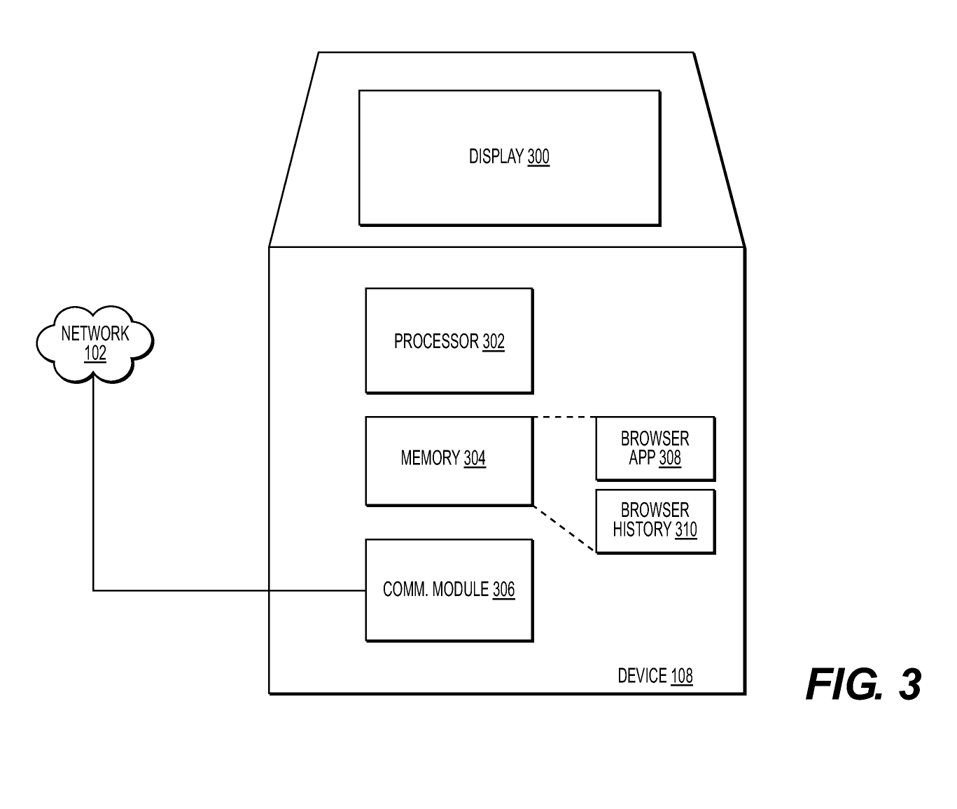

Referring to FIG. 3, device 108a, 108b is a computing device that connects to network 102. Device 108a, 108b is built on a processor-based platform having typical, computing-based components, including display 300, processor 302, memory storage device 304, secondary storage hard drive (not shown) and communication module 306 (providing necessary hardware, software and firmware components to allow device 108a, 108b to connect to outside networks, such as network 102. Applications stored in memory storage device 304 provide instructions executed on processor 302 enabling processor 302 to control features and functions of device 108, receive inputs and process outputs. Browser application 308 generates a set of graphical user interfaces (GUIs) on display 300 and allow inputs to be provided to the GUIs (e.g. from keyboards, mice, touchpads, external devices etc.). It will be appreciated that device 108a, 108b may be a “thin” or “thick” client to network 102. Statistics may be tracked and stored on device 102 in memory storage device 304. For example a data file 310 containing browsing histories generated by browser application 308 may be stored. The browsing histories may include all or some of the data described herein for earlier browsing histories.

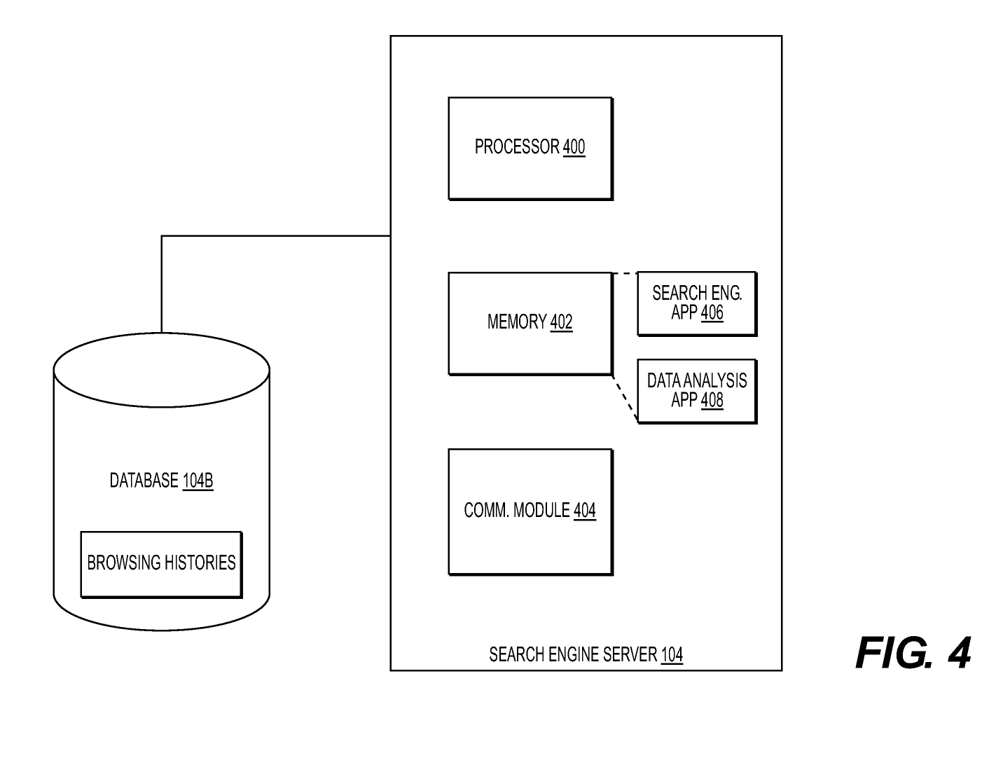

Referring to FIG. 4, server 104 is located in network 102 and also is a computing device. Server 104 may be a single server or comprise multiple servers. Server 104 is a processor-based device having processor 400, memory storage device 402, access to secondary storage database 104b and communication module 404 (providing necessary hardware, software and firmware components to allow server 104 to connect to outside devices and networks, such as device 108a, 108b and network 102. Applications stored in memory 402 provide instructions executed on processor 400 enabling processor 400 to control features and functions of device server 104. Search engine application 406 is stored in memory 402 and provides instructions to processor 400 to analyze data in browsing histories, rank web pages and generate ranked results in response to queries. Search engine application 406 may include algorithms that implement any of the equations as provided herein in determining a page rank.

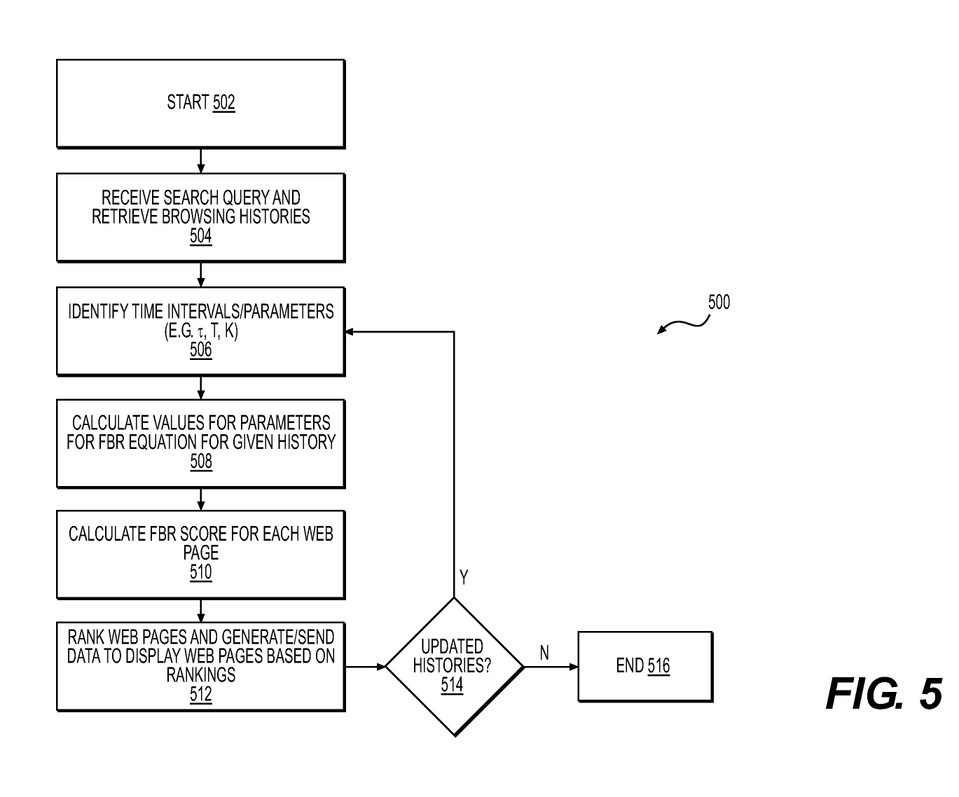

Referring to FIG. 5, process 500 shows a flow chart of exemplary processes executed by search engine application 406 on server 104 through processor 400. After search engine 406 is initiated at start process 502, at some point, server 104 receives a signal that a query has been submitted to it (e.g. from device 108). At that point, process 504 receives the query and initiates a freshness browse rank analysis as described herein. As part of process 504, browse history data is retrieved. The browse history data may be in part, locally accessible (e.g. from database 104a or memory 402) and/or it may be remotely accessible (e.g. from device 108). After the browsing history is retrieved, at process 506, various parameters for the fresh browse rank (FBR) analysis are identified. In one embodiment, time parameters (e.g. τ, T, K) are selected from preset ranges/values. Once parameters have been selected, one or more parameters of an FBR equation (e.g. from Equations 17 and 18) may be calculated for a given browser history per process 508. This may include applying a derivative function to a stationary distribution of a Markov process of a browser history when its transition probabilities are functions of a stationary distribution of another Markov process. One or more of these values may have been previously calculated and simply retrieved by the application. Next at process 510, a FBR score is computed using an appropriate FBR equation (e.g. Equation 10) for each web page in the history. At process 512, all of the web pages are ranked based at least in part on the FBR scores and ranked results may be sent to a device in the network, such as to device 108, which initiated the query. The receiving device (e.g. device 108) can then access the results and a ranked list of web pages would be generated on its display. Next at process 514, a check is made to see if one or more of the browser histories have been updated and/or if another trigger condition has been satisfied (e.g. passage of a predetermined amount of time since the last execution of a ranking, such as a day, week or month, etc., occurrence of a change event in the browsing environment, such as the entry or loss of a predetermined number of browser histories or web pages, etc.). If so, process 500 returns to process 506, but it may instead return to a different process (e.g. process 502, 504, 508, 510 etc.) in another embodiment. Alternatively or additionally, process 500 may initiate an intermediary process (not shown) prior to its return (to process 506) or a different process may be spawned.

It will be appreciated that in other embodiments the order of processes in process 500 may be re-arranged and additional processes may be provided. Process 500 is shown as executing on server 104, but its execution may be distributed among many servers/devices. Process 500 may in part or in whole be executed on device 108.

As an exemplary validation of features of an embodiment, a trial run of a fresh browse ranking algorithm following scoring and ranking features described herein was executed on a browsing history generated from searches conducted on a commercial search engine including approximately 113,000 web pages and 478,000 transitions in the browsing log. For ranking evaluation, a set of queries from the queries submitted by users during over a three day period, where a query was tracked as a query pair containing <text of query, time query>. Each query pair was manually assigned a label based on both the freshness of the page in respect to the query time and the topical relevance of the page to the query.

A relevance score was marked using grading label, such as Perfect, Excellent, Good, Fair, Bad. The browsing data was divided into two parts. In the first part, comprising 75% of the dataset, the parameters were trained as noted and the second part the algorithms described herein was tested. The parameters for a test run for an embodiment were identified by maximizing the loss-function in the way described in above. The parameters for Table A were identified utilizing a maximizing a Normalized Discounted Cumulative Gain (NDCG) metric, producing the following values:

K=24,a≈5.2,b≈1.0,a≈6.9,b≈1.1,μ=0.2,α=0.18,β=0.9.

The value for K was chosen from the set {7, 28, 56, 168}. In these cases the lengths of periods [t₁₊₁, tᵢ] equal to 1 day, 6 hours, 3 hours and 1 hour correspondingly. Table B illustrates results of ranking performance on metrics NDCG@5 and NDCG@10 over ranking algorithms according to an embodiment.

TABLE B

| Algorithm | NDCG@5 | NDCG@10 |
|---|---|---|
| FBR | 0.71256 | 0.784 |
| BR | 0.68312 | 0.75188 |

It will be appreciated that the embodiments relating to client devices, server devices and systems may be implemented in a combination of electronic modules, hardware, firmware and software. The firmware and software may be implemented as a series of processes, applications and/or modules that provide the functionalities described herein, typically by providing instructions for execution on a related processor. The instructions may be stored in a memory storage device on either or both of the client or server devices that is accessible by the processor. Typically, the memory device is locally located in the same device (or near to the same device) housing the processor. The modules, applications, algorithms and processes described herein may be executed in different order(s) and in parallel. Interrupt routines may be used. Data, applications, processes, programs, software and instructions may be stored in volatile and non-volatile devices described and may be provided on other tangible medium, like USB drives, computer discs, CDs, DVDs or other substrates herein and may be updated by the modules, applications, hardware, firmware and/or software. The data, applications, processes, programs, software and instructions may be sent from one device to another via a data transmission.

As used herein, the wording “and/or” is intended to represent an inclusive-or. That is, “X and/or Y” is intended to mean X or Y or both.

In this disclosure, where a threshold or measured value is provided as an approximate value (for example, when the threshold is qualified with the word “about”), a range of values will be understood to be valid for that value. For example, for a threshold stated as an approximate value, a range of about 25% larger and 25% smaller than the stated value may be used. Thresholds, values, measurements and dimensions of features are illustrative of embodiments and are not limiting unless noted. Further, as an example, a “sufficient” match with a given threshold may be a value that is within the provided threshold, having regard to the approximate value applicable to the threshold and the understood range of values (over and under) that may be applied for that threshold.

It will be seen from the disclosure that a technical problem that the disclosure addresses is how to provide improved web page rankings of using browser history data. A further technical problem that the disclosure addresses is how to provide efficient analysis of web browser history data for web page rankings.

The present disclosure is defined by the claims appended hereto, with the foregoing description being merely illustrative of embodiments of the disclosure. Those of ordinary skill may envisage certain modifications to the foregoing embodiments which, although not explicitly discussed herein, do not depart from the scope of the disclosure, as defined by the appended claims.

1. A method of calculating a page rank of a web page, comprising:
accessing browsing history data associated with the web page, the browsing history data comprising time data, wherein the time data comprises first and second instances of time and an interval of time from a first moment in time to a second moment in time;
computing a rank score for the web page utilizing the browsing history data and the time data, comprising,
selecting a sequence of at least one moment in time within the interval of time;
computing a first freshness value and a second freshness value;
the first freshness value computed for each of the at least one moment in time;
the second freshness value computed for a web page associated with each of the at least one moment in time, wherein the second freshness value utilizes a creation time of the web page and the computed freshness values associated with each moment in time for web pages neighbouring the web page;
computing a freshness measure for the web page as a function of the first and second freshness values; and
ranking the web page in a list according to the rank score.

2. The method of calculating a page rank as claimed in claim 1, wherein computing the rank score further comprises:
calculating a first score utilizing a browse rank score of the browsing history data and the time data;
calculating a second score utilizing query dependent component for the web page; and
adding the first score adjusted by a first factor with the second score adjusted by a second factor to produce the rank score.

3. The method of calculating a page rank of claim 1, wherein the first factor is mathematically related to the second factor.

4. The method of calculating a page rank of claim 1, wherein the time data emphasizes browsing data from histories that are more recent than browsing data from older histories.

5. The method of calculating a page rank of claim 1, wherein the computing the rank score further comprises:
applying a derivative function to a stationary distribution of the Markov process associated with the browser history data.

6. The method of calculating a page rank of claim 1, wherein:
the first moment in time and each subsequent moment in time divide the interval of time into two or more sub-intervals of time.

7. The method of calculating a page rank of claim 1, wherein:
computing for the web page the first freshness value utilizes a creation time of the web page and a count of visits to the web page in the browsing history data during a sub-interval of time immediately preceding a sub-interval of time of each moment in time of the sequence.

8. The method of calculating a page rank of claim 7, further comprising:
computing for the web page an interim freshness measure for each moment in time of the sequence utilizing any corresponding computed interim freshness measure associated with a moment in time in the sequence immediately preceding each moment in time, if any and the second freshness value associated with each moment in time,
wherein the computed freshness measure for the web page comprises a computed interim freshness measure associated with the second moment in time.

9. The method of calculating a page rank of claim 1, wherein computing the rank score for the web page utilizes:
a transition probability corresponding to the web page multiplied by a function of the freshness measure.

10. The method of calculating a page rank of claim 1, wherein computing the rank score for the web page further comprises:
multiplying an estimated staying time for the web page derived from a transition matrix for the browsing history data by a function of the freshness measure; and
multiplying a stationary probability distribution for the web page by the function of the freshness measure.

11. The method of calculating a page rank of claim 10, further comprising:
applying partial derivatives to a first function of the rank score for the web page with a training data of browsing histories to identify values for parameters for a second function generating the rank score.

12. The method of calculating a page rank of claim 11, further comprising:
computing a query-dependent ranking for the web page based on a query; and
computing a merged ranking for the web page as a function of the query-dependent ranking and the rank score.

13. A server for calculating a page rank of a web page, comprising:
a processor;
a database for storing records relating to browsing histories; and
page rank software operating on the server providing instructions to the processor executing a method of calculating a page rank of a web page, the method comprising:
accessing browsing history data associated with the web page, the browsing history data comprising time data, wherein the time data comprises first and second instances of time and an interval of time from a first moment in time to a second moment in time;
computing a rank score for the web page utilizing the browsing history data and the time data, comprising:
selecting a sequence of at least one moment in time within the interval of time;
computing a first freshness value and a second freshness value;
the first freshness value computed for each of the at least one moment in time,
the second freshness value computed for a web page associated with each of the at least one moment in time, wherein the second freshness value utilizes at least the computed freshness values associated with each moment in time for web pages neighbouring the web page; and
computing a freshness measure for the web page as a function of the first and second freshness values.
ranking the web page in a list according to the rank score.
